(19) United States
(12) Patent Application Publication
(10) Pub. No.: US 2014/0071254 A1
(43) Pub. Date: Mar. 13, 2014

(54) THREE DIMENSIONAL IMAGING DATA VIEWER AND/OR VIEWING

(71) Applicant: Shlomo Gotman, Haifa (IL)

(72) Inventor: Shlomo Gotman, Haifa (IL)

(73) Assignee: KONINKLIJKE PHILIPS N.V., EINDHOVEN (NL)

(21) Appl. No.: 14/117,708

(22) PCT Filed: May 21, 2012
(86) PCT No.: PCT/IB2012/052531

§ 371 Date: Nov. 14, 2013

Related U.S. Application Data
(60) Provisional application No. 61/492,088, filed on Jun. 1, 2011.

(51) Int. Cl. H04N 13/04

(52) U.S. Cl. CPC H04N 13/0486; H04N 13/0497
USPC 348/53; 348/55

(57) ABSTRACT

A method includes displaying three dimensional medical imaging data in three dimensions via a display monitor (134) by generating and visually presenting a stereoscopic view of the three dimensional medical imaging data in the display monitor. A system includes a stereo processor (114) that processes three dimensional medical imaging data and generates two images from two different viewpoints, which are shifted from each other by a predetermined distance and are angled by a predetermined angle, and a display monitor (134) used to alternately display the two images, thereby creating a stereoscopic view.

### FIELD OF THE INVENTION

The following generally relates to a three dimensional viewer for and/or three dimensional viewing of imaging data generated by one or more imaging modalities such as computed tomography (CT), magnetic resonance (MR), positron emission tomography (PET), and/or other imaging modalities.

### BACKGROUND OF THE INVENTION

Imaging modalities such as CT, MR, PET, etc. generate three dimensional (3D) imaging data indicative of a scanned object or subject. Unfortunately, when the 3D imaging data is visually presented on a 2D display monitor, it is often difficult for the viewer (i.e., the person visually observing the displayed data) to identify depth location of anatomical structure of interest.

While it may be relatively simple to “feel” the depth of a surface-shaded rendering (SSD), and even to make measurements on it, this becomes much more difficult on semi-transparent Volume-Rendered (VR) images. Similarly, Maximum or Minimum Intensity Projection (MIP/MinIP) images, when displayed on a 2D display monitor, do not allow the viewer to identify the relative depth of two overlapping structures (e.g., blood vessels), thus making it more difficult to analyze them during the diagnostic or other reading.

Various techniques have been proposed to overcome these difficulties. One is to apply lighting to create a shading effect. This works well with SSD, but, unfortunately, much less efficient or totally useless with MIP/MinIP and semi-transparent VR images. Another approach is to rotate (or “shake”) the images, thus increasing the feeling of depth (which may useful with MIP images). Unfortunately, with this approach, once the rotation/move is stopped, (e.g., to allow other manipulation on images such as measurements), the depth effect disappears.

In view of at least the above, there is an unresolved need for other approaches for visually presenting 3D imaging data.

### SUMMARY OF THE INVENTION

Aspects of the present application address the above-referenced matters and others.

According to one aspect, a method includes displaying three dimensional medical imaging data in three dimensions via a display monitor by generating and visually presenting a stereoscopic view of the three dimensional medical imaging data in the display monitor.

In another aspect, a system includes a stereo processor that processes three dimensional medical imaging data and generates two images from two different viewpoints, which are shifted from each other by a predetermined distance and are angled by a predetermined angle, and a display monitor used to alternately display the two images, thereby creating a stereoscopic view.

In another aspect, a computer readable storage medium is encoded with one or more computer executable instructions, which, when executed by a processor of a computing system causes the processor to: generate and stereoscopically display three dimensional image data via a two dimensional display monitor.

Still further aspects of the present invention will be appreciated to those of ordinary skill in the art upon reading and understand the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an example three dimensional viewing

system.

FIG. 2 schematically illustrates an example GUI for displaying images and/or sub-menus for presenting user selectable options.

FIG. 3 schematically illustrates an example GUI for selecting between mono and stereo modes of operation.

FIG. 4 schematically illustrates an example GUI for providing and/or changing various parameters and/or invoking a measurement tool for stereo mode.

FIG. 5 schematically illustrates an example GUI for selecting a measurement tool.

FIG. 6 schematically illustrates an example of selecting a view direction that is perpendicular to the structure being viewed.

FIG. 7 schematically illustrates an example of selecting a view direction that is not perpendicular to the structure being viewed.

FIG. 8 schematically illustrates an example of rendering a 2D image in mono mode.

FIG. 9 schematically illustrates an example of rendering a 3D or stereoscopic view in stereo mode.

FIG. 10 schematically illustrates an example of generating the stereoscopic view of FIG. 9.

FIG. 11 schematically illustrates an example rendering with the focus point located closer to the viewpoints.

FIG. 12 illustrates an example rendering with the focus point located between the viewpoints and the structure being observed.

FIG. 13 illustrates an example rendering with the focus point located farther from the viewpoints.

FIG. 14 illustrates an example rendering with the focus point located behind the structure being observed.

FIG. 15 illustrates an example method for displaying 3D data.

### DETAILED DESCRIPTION OF EMBODIMENTS

The following generally describes an approach in which imaging data (CT, MR, PET, etc.) is presented in 3D via a 2D display monitor by generating two images from two different viewpoints (e.g., left and right) that are shifted from each other by a predetermined distance (e.g., 10 mm) and/or angled by a predetermined angle (e.g., ±10 degrees), and visually presenting the two images stereoscopically. The values for the shift and angle can be default and/or user specified, and based on desired visible characteristics.

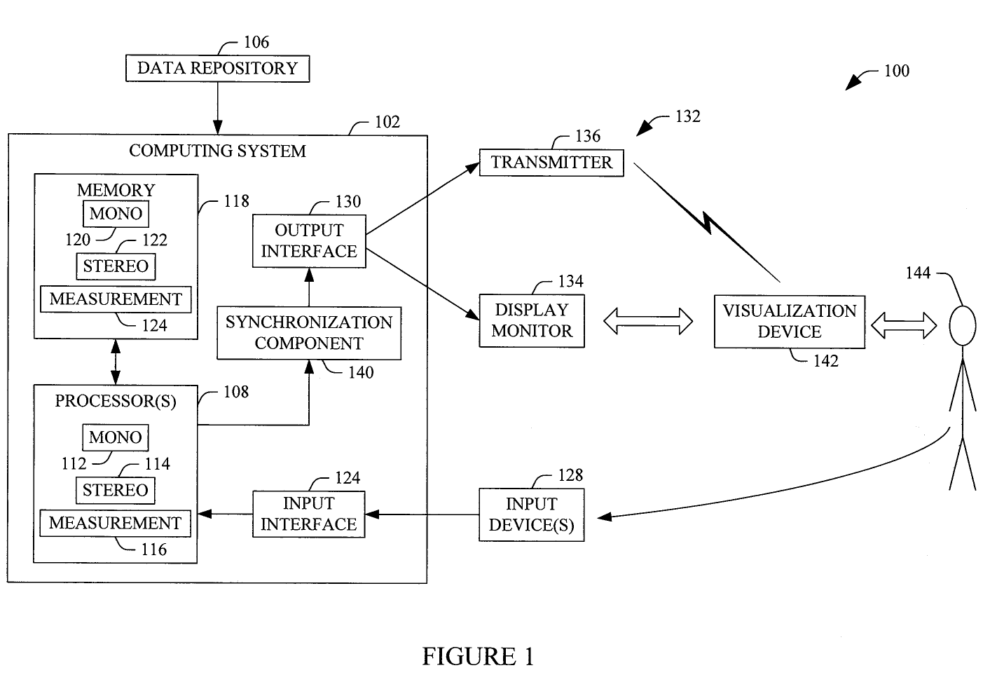

FIG. 1 illustrates a three dimensional viewing system 100. The system 100 includes a computing apparatus 102 that processes and visually presents three dimensional (3D) imaging data in three dimensions. Such data includes, but is not limited to, CT, MR, PET, etc. imaging data, which can be obtained from a data repository 106 such as a picture archiving and communication system (PACS), a radiology information system (RIS), a hospital information system (HIS), an electronic medical record (EMR) database, a sever, a computer, and/or other data repository. The data repository 106 may also include information other than imaging data. Additionally or alternatively, the imaging data can be obtained from an imaging system generating the data.

The computing apparatus 102 includes one or more processors 108, including a mono processor 112, a stereo processor 114, and a measurement processor 116. In another embodiment, a single processor is used as the processors 112, 114 and/or 116. The mono processor 112 processes 3D imaging data and generates 2D images as observed from a single viewpoint looking into the 3D imaging data. Conventional or other approaches can be used to generate such imaging data. The measurement processor 116 is configured to determine various measurements in two and/or three dimensional space, including, but not limited to, distance, angle, etc.

The stereo processor 114 processes the 3D imaging data and generates two images as observed from two different viewpoints looking into the 3D imaging data. As described in greater detail below, the two viewpoints represent different perspectives (e.g., left and right eye) and are separated from each other by a non-zero distance and/or angled by a non-zero angle. Images corresponding to the different viewpoints are alternately presented. In one instance, this allows for visually presenting the two images stereoscopically, providing a user with an intuitive 3D perception of the true volumetric nature of the displayed structure, including, but not limited to, depth information.

Memory 118 is used to store one or more sets of computer executable instructions executable, which can be executed by the one or more processors 108. In the illustrated embodiment, the memory 118 stores at least mono 120 and stereo 122 mode and measurement 124 computer executable instructions correspondingly for the mono processor 112, the stereo processor 114 and the measurement processor 116. Other information stored in the memory 118 may include image processing instructions such as rotate, zoom, pan, set opacity, select a rendering algorithm, sculpt, etc. The computer executable instructions may additionally or alternatively be stored in other physical memory, and/or additionally or alternatively in a signal or carrier medium.

An input interface 126 includes various ports, connectors, and the like for mechanically and electrically interfacing input devices 128 such as a mouse, a keyboard, or the like. The input interface 126 receives signals in response to a user using the input devices to provide input or information to the computing apparatus 102. An output interface 130 includes various ports, connectors, and the like for mechanically and electrically interfacing output devices 132 such as a display monitor 134 (e.g., a 120 Hz monitor), a transmitter 136, and/or other output device. The display monitor 134 can be used to present 2D and 3D images as well as GUIs with user selectable options and/or features. Suitable input and/or output interfaces include USB and/or other interfaces.

A synchronization component 140 generates and conveys a synchronization or timing signal along with the stereo mode data. By way of example, where the stereo processor 114 generates two images, one from each of the viewpoints, and the two images are alternately presented via the monitor 134, the synchronization signal provides information indicating which of the two images is being displayed, the rate at which the images are to be displayed, etc. For mono mode, the synchronization component 140 acts as a pass through or can be bypassed.

The transmitter 136 communicates the synchronization signal to a visualization device 142 utilized by a user 144 to view the stereoscopic rendered data. Examples of suitable communication include infrared (IR), radio frequency (RF), optical, acoustic, blue tooth, etc. The synchronization signal allows the visualization device 142 to operate in coordination with the alternating of the displayed images. By way of example, the synchronization signal invokes the visualization device 142 to operate in a first manner to view a first of the two images and to operate in a second manner to view a second of the two images.

An example of a suitable visualization device 142 includes, but is not limited to, a pair of liquid crystal (LC) shutter glasses in which each eye glass contains a liquid crystal layer which has the property of becoming dark (or opaque) when voltage is applied and being generally transparent otherwise. Such glasses are configured to alternately darken over one eye, and then the other, in synchronization with the alternating of the displayed images. In this example, the two images respectively correspond to an image as observed from the right eye of the user and an image as observed from the left eye and the shutter glasses are controlled so that the right lens is transparent and the left lens is opaque for the right image and vice versa.

In one instance, each lens operates at 60 Hz and both lenses alternate to collectively operate at 120 Hz for use with 120 Hz monitors (such as the display monitor 134), projectors, and passive-polarized displays. Such shutter glasses can be operated under power supplied by a rechargeable or non-rechargeable battery, alternating current (AC), or other power supply. Where a rechargeable battery is utilized, the battery can be charged via an internal charger with power supplied through a USB or other cable, an external charger that supplies charge power, or removed from the shutter glasses and charged in a remote battery charger.

An example of a pair of suitable LC shutter glasses in included in 3D Vision™, which is a stereoscopic gaming kit from the Nvidia corporation, a company headquarted in Santa Clara, Calif., USA.

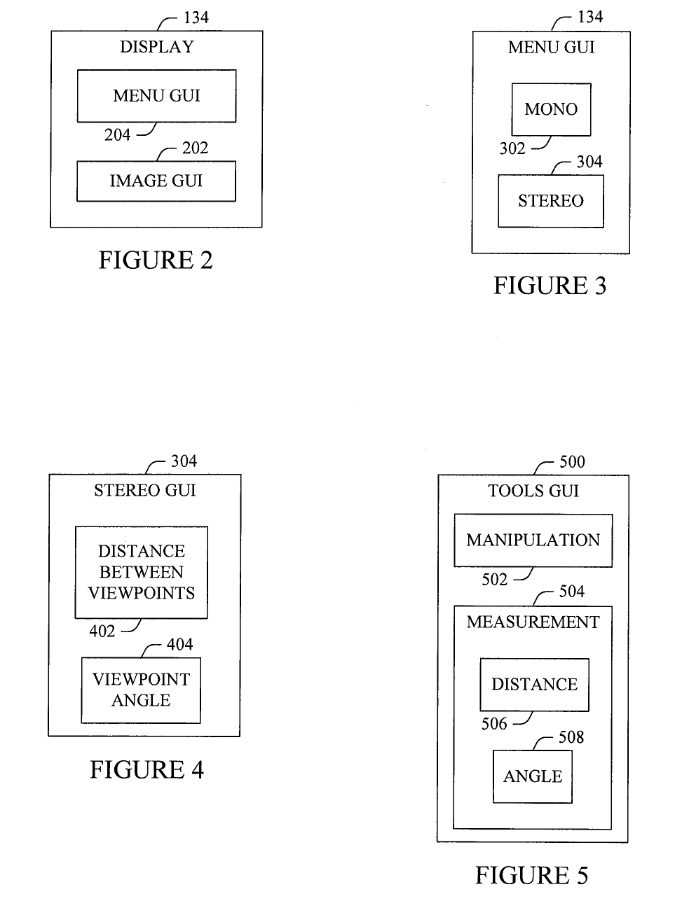

As briefly discussed above, the computing system 102 can present GUIs for image display and/or with user selectable options. FIGS. 2, 3, 4 and 5 illustrate examples of such GUIs.

Initially referring to FIG. 2, both an image GUI 202 and a menu GUI 204 are visually presented in the display 134. The image GUI 202 can be used to present individual 2D or 3D images or, concurrently, multiple 2D and/or 3D images. Examples of such images include an image used to select an initial view direction looking into the imaging data, one or more mono images, and/or one more stereo images. The menu GUI 204 visually presents user selectable graphical indicia corresponding to various options and sub-options provided by the system 100.

As shown in FIG. 3, the menu GUI 204 includes user selectable options for selecting between mono 302 and stereo 304 processing modes. As shown in FIG. 4, options for stereo mode include a distance between viewpoints 402 option to set or change the distance between viewpoints and a viewpoint angle 404 options to set or change the angle between viewpoints. In one instance, this GUI is presented automatically upon selecting stereo 304 mode. In another, a stereo image is presented using default settings, and the menu options 402 and 404 are utilized when the user wants to adjusts certain features.

As shown in FIG. 5, a tools GUI 500 includes a user selectable image manipulation 502 option, which provides tools to rotate, zoom, pan, set opacity, select a rendering algorithm, sculpt, etc. displayed imaging data, while still viewing the imaging data presented in stereo mode. The tool GUI 500 also includes user selectable measurement options 504 such as a distance 506 option for measuring the length between two user defined points and an angle 508 option for measuring the angle defined in connection with three user defined points (or two line segments extending from the same vertex).

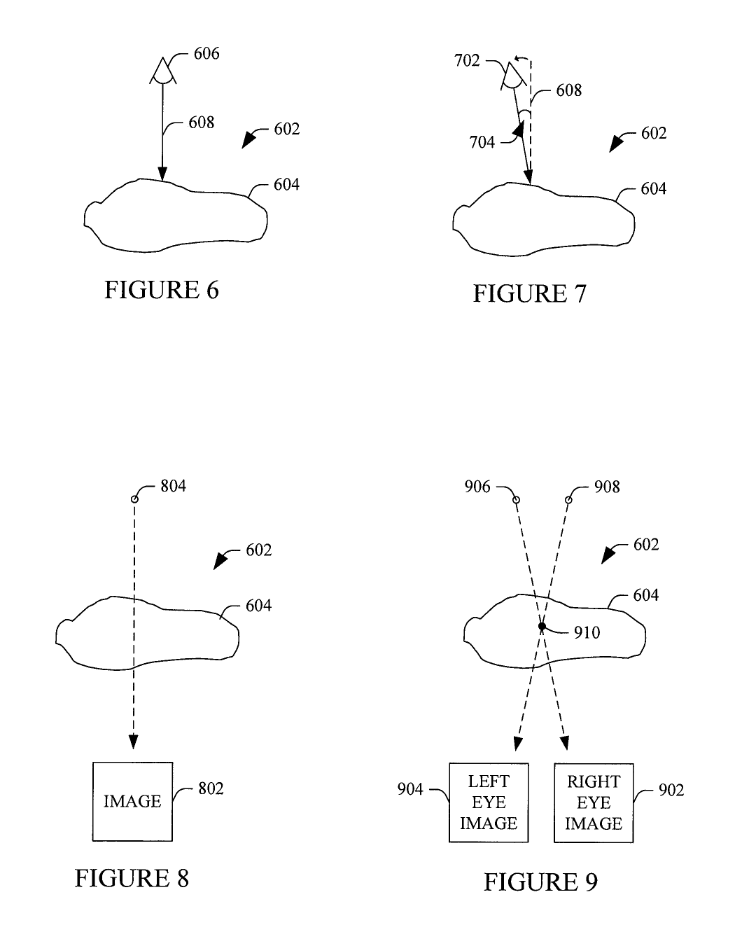

FIGS. 6 and 7 illustrate the process of selecting an initial view direction in connection with imaging data.

In FIG. 6, the system 102 presents imaging data 602, including structure 604, via the display monitor 134. A user of the system 100 uses an input device 128 to select a view direction 606 in connection with the structure 604. The computing apparatus 102 receives and processes a signal indicative of the user selection. In another instance, a default view direction is utilized. Generally, the view direction 606 defines a direction of interest into the structure 602, and the mono or stereo images are rendered based on this direction so that a user viewing the image via the display 134 views the image from the direction of interest. In this embodiment, the view direction 606 traverses a path 608 which is perpendicular to the structure 604.

As shown in FIG. 7, in an alternative embodiment, the user used the input device 128 to select a view direction 702, which is angularly offset from the path 608 perpendicular to the structure 604 by an angle 704. Other angles are also contemplated herein. For example, the user can the input device 128 to variously manipulate the displayed image (e.g. rotate, etc.) and select a view direction anywhere outside of, on, or inside of a geometric shape encompassing the structure 604.

FIG. 8 illustrates generating and presenting an image in mono mode. In FIG. 8, a single 2D image 802 is generated by the mono processor 112 based on the view direction 606 (FIG. 6) and conveyed to the display monitor 134 where it is visually presented so that the user can view the image 802 from a viewpoint 804, which corresponds to the view direction 606.

FIG. 9 illustrates generating and presenting images in stereo mode. In FIG. 9, two 2D images 902 and 904 in connection with two viewpoints 906 and 908 and corresponding to a perspective views from the right eye and from the left eye are generated. As shown, the two viewpoints 906 and 908 are shifted from each other and angled in a direction towards each other. In this embodiment, the angle is set such that a focus point 910 is about at a mid-region of the structure 604. As such, the mid-region of the structure 604 will align with the display monitor's viewing plane when the images 902 and 904 are displayed.

In FIG. 9, the 2D images 902 and 904 are alternately visually presented via the display monitor 134 so that only one of the 2D images 902 and 904 is visually presented via the display monitor 134 in any given frame. As discussed herein, the synchronization signal is conveyed to the visualization device 142, which alternates the right and left lenses of the shutter glasses in synchronization and in coordination with the alternating of the right and left images 902 and 904 in the display monitor 134, providing a 3D presentation based on the stereoscopic effect.

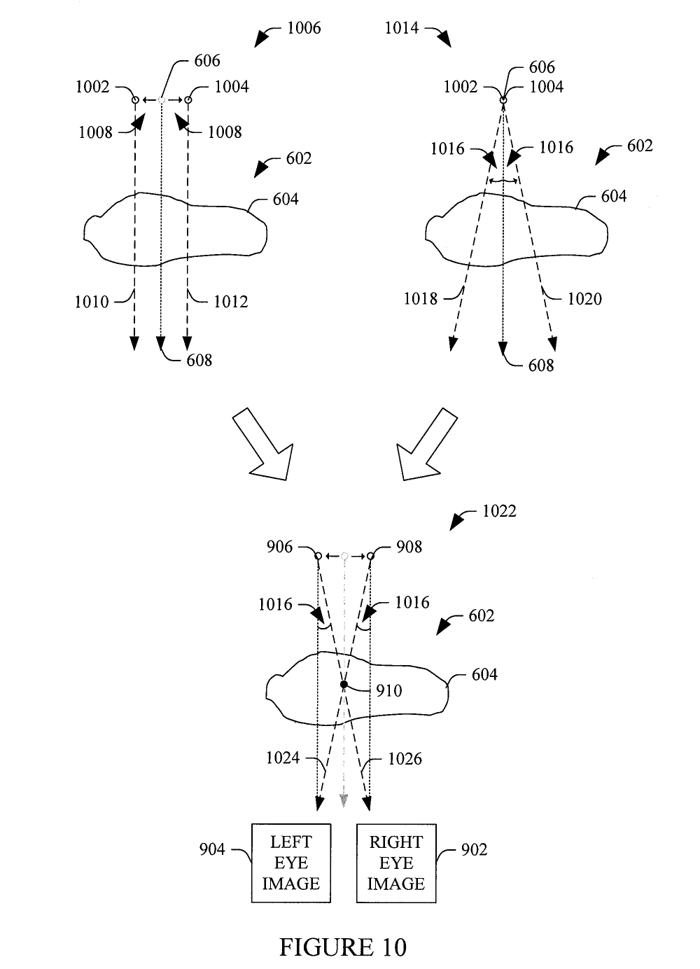

FIG. 10 further illustrates the shifting and angling shown in connection with FIG. 9.

At 1006, right and left viewpoints 1002 and 1004 are shifted from the view direction 606 by a predetermined shift 1008 (e.g., ±three (3) millimeters (mm)). The viewpoints 1002 and 1004 define paths 1010 and 1012 that are generally parallel to the path 608. As discussed herein, the user can set or adjust the shift 1008, e.g., using the distance between viewpoints 402 option shown in connection with FIG. 4.

At 1014, the right and left viewpoints 1002 and 1004 are angled at the view direction 606 by a predetermined angle 1016 (e.g., ±three (3) degrees) from the path 608. The viewpoints 1004 and 1006 define paths 1018 and 1020, which extend from the view direction 606 away from each other. As discussed herein, the user can set or adjust the angle 1016, e.g., using the viewpoint angle 404 option shown in connection with FIG. 4.

Although the above describes shifting before angling, it is to be appreciated that such shifting can be performed before, concurrently with, or after angling.

At 1022, the shifted and angled of the viewpoints 1002 and 1004 are combined to generate the viewpoints 906 and 908. In FIG. 10, the separated viewpoints 906 and 908 extend along paths 1024 and 1026, which are angled respectively in connection with paths 1028 and 1028 extending perpendicularly from the viewpoints 906 and 908 to the structure 604.

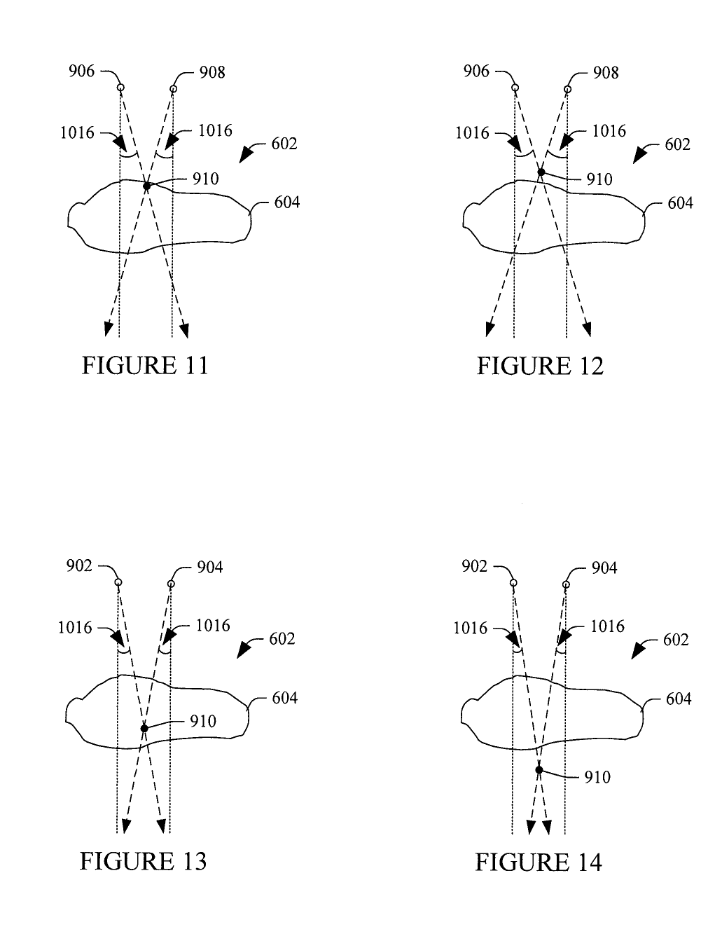

In FIGS. 9 and 10, the focus point 910 is approximately in a mid-region of the structure 604. As shown in FIGS. 11, 12, 13 and 14, the user can change the focus point 910 by varying the angle 1016, using the viewpoint angle 404 option of the stereo 304 GUI (FIG. 4). This allows the user to place the structure 604 in front of, behind or in the screen plane of the display monitor 134.

In FIG. 11, the value of the angle 1016 is set larger than the value of 1016 in FIGS. 9 and 10. In FIG. 11, the angle 1016 is such that the focus point 910 shifts towards the viewpoints 906 and 908, but remains in the structure 604, which moves the structure 604 back with respect to the screen plane.

In FIG. 12, the value of the angle 1016 is set larger than the value of 1016 in FIG. 11. In this instance, the focus point 910 shifts towards the viewpoints 906 and 908 and is located between the viewpoints 906 and 908 and the structure 604. This gives the appearance of the structure 604 being behind the screen plane.

In FIG. 13, the value of the angle 1016 is set smaller than the value of 1016 in FIGS. 9 and 10. The angle 1016 is such that the focus point 910 shifts away from the viewpoints 906 and 908, but remains in the structure 604, which moves the structure 604 forward with respect to the screen plane.

In FIG. 14, the value of the angle 1016 is set smaller than the value of 1016 in FIG. 13. In this instance, the focus point 910 shifts away from the viewpoints 906 and 908 and is located between behind the structure 604, opposite the viewpoints 906 and 908. This gives the appearance of the structure 604 being in front of the screen plane.

Once in stereo mode, the user can place and move (in x, y and z) one or more three-dimensional pointers “within” the semi-transparent image using the manipulation 502 and/or measurement 504 GUIs and/or otherwise.

For placing a pointer, the user provides an input via the input devices 128 that identifies a location for the 3D pointer in the image in three dimensional space. The computing apparatus 102 receives a signal corresponding to the input and generates a 2D pointer in each of the images. A 3D pointer is superimposed with the 3D model and displayed as part of the stereoscopic image.

For a distance measurement, the user provides one or more inputs that identify two points in the 3D imaging data via the 3D pointer. The computing apparatus 102 receives a signal corresponding to the input, and the two points are superimposed with the 3D model and displayed as part of the stereoscopic image. A distance between the two points is calculated and presented to the user.

For an angle measurement, the user provides one or more inputs that identify three points in the 3D imaging data, via the 3D pointer, which form two line segments extending from a same vertex (one of the points). The computing apparatus 102 receives a signal corresponding to the input, and the three points (or two line segments) are superimposed with the 3D model and displayed as part of the stereoscopic image. The angle between the two line segments is calculated and presented to the user.

It is to be appreciated that the approach described herein facilitates overcoming various short coming of traditional single viewpoint approaches by producing a 3D stereoscopic view with a very realistic depth effect while allowing conventional or other image manipulation and navigation as usual. This depth effect allows direct pointing in the 3D space even in MIP/MinIP or semi-transparent VR images. It also allows 3D measurements to be made on such images, which general is not be possible on 2D projections

Variations are contemplated.

In another embodiment, the system 100 stereoscopically renders three dimensional images using autostereoscopy, or glasses free 3D. With this approach, the transmitter 136, the synchronization component 140, and the visualization device 142 can be omitted. With autostereoscopy, two technologies are generally utilized: those that use eye-tracking, and those that display multiple views so that the display does not need to sense where the viewers' eyes are located. Examples of autostereoscopic displays include parallax barrier, lenticular, volumetric, electro-holographic, and light field displays, and available with 3DTV screens or 3D smart phones.

FIG. 1 is described in the context of the computing system 100. In a variation, the system 100 can alternative be employed in a client/server environment. In this environment, the stereoscopic images and the synchronization signal are generated at the server and conveyed to the client where they are displayed. The client computer then alternately displays the images and conveys the synchronization signal to the shutter glasses, which controls the lenses based on the synchronization signal to synchronize alternately switching the lenses between transparent and opaque in coordination with displaying the images. Changes to the viewpoint, mode, distance between viewpoints, viewpoint angle, 3D pointers, etc. are made at the client computer, conveyed to the server where the stereoscopic images are re-rendered based on the changes, and the new stereoscopic images are conveyed to the client for display.

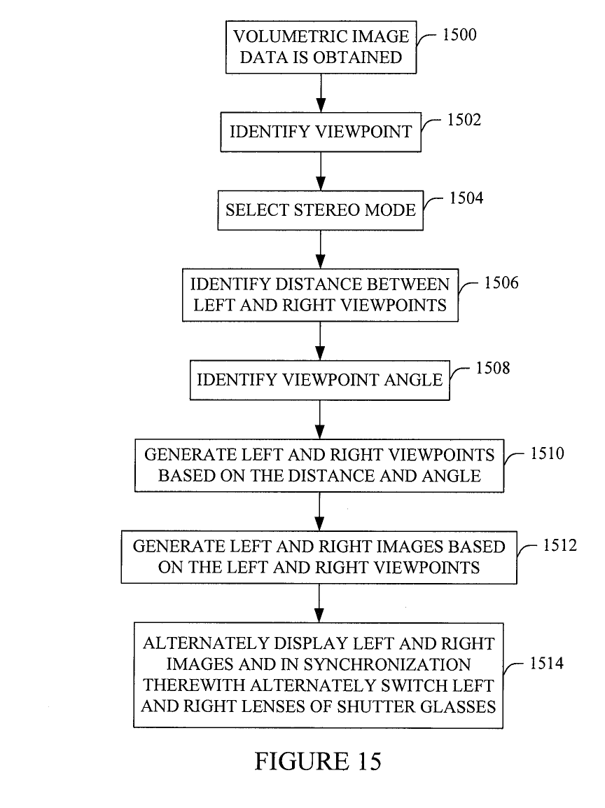

FIG. 15 schematically illustrates example method for displaying volumetric imaging data in three dimensions via a two dimensional display monitor 134.

It is to be appreciated that the ordering of the below acts is for explanatory purposes and not limiting. As such, other orderings are also contemplated herein. In addition, one or more of the acts may be omitted and/or one or more other acts may be included.

At 1500, volumetric imaging data is obtained. As discussed above, this data can be obtained from the data repository 106 and/or elsewhere.

At 1502, a view direction looking into the volumetric imaging data is identified for the imaging data. For example, the user of the apparatus 102 can use the input devices 128 to provide an input that identifies a view direction of interest such as the view direction 606, and the apparatus 102 receives a signal indicative of the view direction 606.

At 1504, stereo mode is selected. For example, the user of the apparatus 102 can use the input devices 128 to provide an input that identifies the stereo mode, and the apparatus 102 receives a signal indicative of identified mode and operates in stereo mode.

At 1506, a distance between left and right viewpoints is identified. As discussed herein, this distance may be a default or user defined distance. A default and/or user defined distance may be retrieved from the memory 118. Alternatively, the user can employ the input devices 128 to provide an input that identifies the distance, and the apparatus 102 receives a signal indicative of identified distance.

At 1508, a viewpoint angle for the left and right viewpoints is identified. As discussed herein, this angle may be a default or user defined angle. A default and/or user defined angle may be retrieved from the memory 118. Alternatively, the user can employ the input devices 128 to provide an input that identifies an angle of interest such as angle 1016, and the apparatus 102 receives a signal indicative of the angle 1016.

At 1510, the left and right viewpoints are generated based on the identified viewpoint, distance and angle. This can be achieved as described herein, for example, as discussed in connection with FIGS. 9 and 10.

It is to be appreciated that act 1508 can be performed before, concurrently with or after act 1510.

At 1512, a left image is generated based on the left viewpoint 904 looking into the imaging data and a right image is generated based on the right viewpoint 906 looking into the imaging data.

At 1514, the left and right images are alternately presented via the display monitor 134 and, concurrently in synchronization therewith, left and right lenses of a pair of shutter glasses are alternately switched between transparent and opaque, thereby providing a 3D image, stereoscopically.

At 1516, optionally, a 3D pointer can be generated and superimposed within the stereoscopic 3D image. For this, the user can employ the input devices 128 to provide an input that identifies placement of the 3D pointer, and the apparatus 102 receives a signal indicative of the identified placement, includes the pointer in each of the images, and the 3D pointer is generated when alternately displaying the images.

At 1518, optionally, the 3D pointer can be used to identify points for making distance and/or angle measurements in the 3D image. For this, the user can employ the input devices 128 to provide an input that identifies multiple points via the 3D pointer, and the apparatus 102 receives a signal indicative of the multiple points and makes the measurement based on the multiple points.

The above may be implemented via one or more processors executing one or more computer readable instructions encoded or embodied on computer readable storage medium such as physical memory which causes the one or more processors to carry out the various acts and/or other functions and/or acts. Additionally or alternatively, the one or more processors can execute instructions carried by transitory medium such as a signal or carrier wave.

The invention has been described herein with reference to the various embodiments. Modifications and alterations may occur to others upon reading the description herein. It is intended that the invention be construed as including all such modifications and alterations insofar as they come within the scope of the appended claims or the equivalents thereof.

1. A method, comprising:
displaying three dimensional medical imaging data in three dimensions via a display monitor by generating and visually presenting a stereoscopic view of the three dimensional medical imaging data in the display monitor;
receiving an input identifying points in the three dimensional medical imaging data;
determine a measurement based on the points; and
visually presenting measurement.

2. The method of claim 1, wherein generating and visually presenting the stereoscopic view includes generating two images from two different viewpoints that are shifted from each other by a predetermined distance and/or angled by a predetermined angle, and alternately presenting the two images via the display monitor.

3. The method of claim 1, further comprising:
receiving a first signal indicative of a view direction looking into the medical imaging data;
obtaining a second signal indicative of a distance between two viewpoints;
obtaining a third signal indicative of an angle of the two viewpoints;
generating First and second viewpoints based on the first, second and third signals; and
generating first and second images based on the medical imaging data and the first and second viewpoints, wherein the first image represents a perspective from a left or right eye of a human viewer and the second image represents a perspective from the other of the left or right eye of the human viewer.

4. The method of claim 3, further comprising:
alternately displaying the first and second images via the display monitor and concurrently transmitting a synchronization signal to a pair of shutter glasses utilized to view the displayed first and second images, wherein the synchronization signal causes left and right lenses of the shutter glasses to alternately transition between transparent and opaque in synchronization with the alternately displaying the first and second images.

5. The method of claim 3, further comprising:
alternately displaying the first and second images using autostereoscopy,

6. The method of claim 1, further comprising:
receiving a change in distance signal indicative of a new distance between the two viewpoints; and
generating new first and second images based on the new distance,

7. The method of claim 1, further comprising:
receiving a change in angle signal indicative of a new angle of the viewpoints; and
generating subsequent first and second images based on the new angle.

8. The method of claim 7, wherein the angle places the imaging data in a viewing plane of the display monitor.

9. The method of claim 7, wherein the angle places the imaging data in front of a viewing plane of the display monitor.

10. The method of claim 7, wherein the angle places the imaging data behind a viewing plane of the display monitor.

11. The method of claim 1, further comprising;
generating a pointer in both the first and second images, wherein alternately displaying the first and second images superimposes a three dimensional pointer in the displayed three dimensional medical imaging data.

12. The method of claim 11 further comprising;
receiving a change in position of the pointer signal indicative of a new pointer position in the displayed three dimensional medical imaging data: and
generating subsequent first and second images based on the new pointer position,

13. The method of claim 11, wherein the input corresponds to a distance measure signal indicating two points within the displayed three dimensional medical imaging data; and further comprising:
calculating a distance value indicative of a distance between the two points; and
visually presenting the distance value.

14. The method of claim 10, wherein the input corresponds to an angle measure signal indicating three points within the displayed three dimensional medical imaging data, wherein one of the points represents a vertex and the other two points define line segments from the vertex; and further comprising;
calculating an angle value indicative of an angle between the line segments; and
visually presenting the angle value.

15. A system, comprising:
a stereo processor that processes three dimensional medical imaging data and generates two images from two different viewpoints, which are shifted from each other by a predetermined distance and are angled by a predetermined angle;
a display monitor used to alternately display the two images, thereby creating a stereoscopic view; and
a measurement processor that calculates a measurement based on an input indicative of points in the stereoscopic view.

16. The system of claim 15, further comprising;
a synchronization component that generates a synchronization signal that indicates which image is being displayed, wherein the synchronization signal is conveyed to a pair of shutter glasses to control transition of left and right lenses of the shutter glasses alternately between transparent and opaque states in coordination with the alternately of the displayed the two images.

17. The system of claim 15, wherein the stereo processor is further configured to generate a pointer in each of the two images, wherein alternately displaying the two images creates a three dimensional pointer in the stereoscopic view.

18. The system of claim 17, wherein the three dimensional pointer is moveable in the three dimensions hi die stereoscopic view.

19. The system of claim 15, wherein the measurement processor calculates a distance between the points.

20. The system of claim 15,
wherein the measurement processor calculates an angle between line segments formed by the stereoscopic view.

21. The system of claim 15, wherein the predetermined distance is a value in a range from one to ten millimeters.

22. The system of claim 15, wherein the predetermined angle is one to ten degrees.

23. The system of claim 15, wherein the stereo processor, the synchronization component, and the display monitor are part of a same computing apparatus.

24. The system of claim 15, wherein the stereo processor is part of a server and the display monitor is part of a client computer, and the sever conveys the two images to the client, which alternately displays the two images to provide the stereoscopic view.

25. A computer readable storage medium encoded with one or more computer executable instructions, which, when executed by a processor of a computing system causes the processor to; generate and stereoscopically display three dimensional image data via a two dimensional display monitor; and
visually present a measurement determined from an input indicative of points in the displayed three dimensional image data.
